(19) United States
(12) Patent Application Publication
(10) Pub. No.: US 2026/0318125 A1
(43) Pub. Date: Oct. 15, 2026

(54) MOTOR VEHICLE LOCK

(71) Applicant: Kiekert Aktiengesellschaft, Heiligenhaus (DE)

(72) Inventors: Jakub ŠPITZER, Pardubice (CZ); Miroslav JAKEŠ, Cáslav (CZ)

(73) Assignee: Kiekert Aktiengesellschaft, Heiligenhaus (DE)

(21) Appl. No.: 19/104,250

(22) PCT Filed: Aug. 16, 2023
(86) PCT No.: PCT/DE2023/100606

§ 371 Date: Feb. 17, 2025

(30) Foreign Application Priority Data
Aug. 26, 2022 (DE) 10 2022 121 658.6

(51) Int. Cl. E05B 81/90; E05B 81/06; E05B 81/14

(52) U.S. Cl. CPC E05B 81/90; E05B 81/06; E05B 81/14

(57) ABSTRACT

The invention relates to a motor vehicle lock, in particular a motor vehicle door lock, which is equipped with a locking mechanism (I, 2) substantially comprising a rotary latch (I) and a pawl (2). Moreover, an electric motor drive (4, 5) is produced which selectively shifts a coupling element (6) of an actuating lever chain (3, 6, 7) into the “engaged” and “disengaged” positions. According to the invention, the electric motor drive (4, 5) acts, via a pushing member (8), on the coupling element (6) mounted on an actuating lever (7). The pushing member (8) has a blocking element (9) which interacts with a stationary counter-blocking element (IO) in order to release the coupling element (6) depending on the position.

The invention relates to a motor vehicle lock, in particular a motor vehicle door lock, with a latch mechanism consisting essentially of a rotary latch and a detent pawl, and with an electromotive actuator that applies force to move a coupling element of an actuation lever chain selectively into the “engaged” and “disengaged” positions.

Motor vehicle locks and in particular motor vehicle door locks of the prior art are used in different variants and in a wide range of positions within and on a motor vehicle. In fact, these include hatchback locks, front hood locks, gas tank flap locks, and even seat adjustment locks. In general, said motor vehicle locks, and in particular motor vehicle door locks, are produced on the side doors of motor vehicles.

At this position, electromotive actuators are often utilized, which are deployed as opening actuators for electrically opening the latch mechanism. This is especially advantageous for reasons of convenience and acoustics. By aid of such electromotive opening actuators, the latch mechanism, consisting of a rotary latch and detent pawl, can be opened when in the locked position by aid of the respective actuator by, for example, lifting the detent pawl by aid of a release lever away from its latching engagement with the rotary latch. In this way, the rotary latch opens, under spring tension, and releases a previously caught lock bar and thus the associated motor vehicle door.

In addition to an opening process like this, the cited electromotive actuators can also be used to apply force to the coupling element.

Thus, by aid of the electromotive actuator, the coupling element of the actuation lever chain can be shifted selectively into the “engaged” and “disengaged” positions. In the “engaged” position, the actuation lever chain is mechanically closed. This also corresponds to the “unsecured” or “unlocked” condition of the actuation lever chain. On the other hand, when the coupling element assumes its “disengaged” position, the actuation lever chain in question is mechanically interrupted. This corresponds to the “secured” or “locked” functional condition.

In a crash or a loss of the electrical power supply of the electromotive actuator, for opening the latch mechanism emergency measures are required, in order to be able nonetheless to open the latch mechanism mechanically on an emergency basis. In this way, for example, arriving rescue personnel are provided with the desired access to the motor vehicle. This process is referred to as “temporary crash redundancy (TCR),” because the actuation lever chain in question is mechanically closed for a limited time (temporarily) to initiate a manual opening process.

Typically, in normal operation the actuation lever chain assumes its “secured” or “locked” condition. The actuation lever chain is therefore interrupted. This condition can also be resumed following the described crash case.

That is, in the example, the actuation lever chain in question is open in general and in normal operation, so that in normal operation no force can be applied to the latch mechanism by aid of the actuation lever chain. Rather, in such a case, the electromotive actuator provides for electromotive opening. However, when it comes to an emergency operation and thus an emergency opening, for example in case of a crash, the actuation lever chain is mechanically closed. This is effected by the coupling element, which is shifted in this case to its “engaged” position.

As a consequence, arriving rescue personnel, for example, can open the latch mechanism mechanically and manually using the actuation lever chain that has been closed in this way.

Such a procedural method has proven its value fundamentally, as the groundbreaking patent DE 10 2019 132 764 A1 makes clear. In it, an electromotive actuator is produced that applies force to a safety element. By aid of the safety element, a safety mechanism can be triggered to assume its safety position. Besides this electromotive actuator, an electromotive opening actuator is additionally produced. From a design standpoint, this is complex.

In comparable prior art according to EP 3 800 310 A1, which originated with the applicant, a process is followed in which the electromotive actuator acts on the latch mechanism in an opening direction to open it and applies force to a safety lever in a different safety-release direction to make it assume its final safety position. In addition, a stop is provided for the electromotive actuator, which limits the motion of the electromotive actuator in order to clear the final safety position, at least when it applies force in the opening direction. The stop acts reciprocally on a blocking element. In this way, an additional control actuator for the blocking element can indeed be dispensed with, but nonetheless additional functional elements and levers are required for it.

The state of the art has generally retained its value when it comes to the motor-driven application of force to a coupling element of an actuation lever chain. However, further improvements are possible at this locus. In fact, in connection with such electromotive actuators for the coupling element, the necessity exists, for example, to be able to and to wish to open the actuation lever chain (which is “locked” in normal operation) mechanically and manually even without application of force by the electromotive actuator.

This can be done by means of a single-pull operation, for example on an exterior or interior door handle. As a rule, however, for safety reasons a double-pull operation for opening the latch mechanism is favored.

With the first pull, the exterior or interior door handle causes the actuation lever chain to shift from its “secured” or “locked” condition, assumed in normal operation, to the “un-secured” or “unlocked” position. With the next/second pull, the latch mechanism can be opened, via the actuation lever chain that has been mechanically closed in this way. It has not been previously possible to combine such a double-pull operation with an electromotive actuator for the coupling element, however, which is designed for example as a so-called “TCR actuator.” This actuator ensures, only in case of a crash, that the coupling element is shifted from its original “disengaged” position, assumed in normal operation, into the “engaged” position.

The electromotive actuator in question is usually set up and provided additionally for electric or electromotive opening of the latch mechanism. In any case, convincing, functionally appropriate and simply structured solutions have been lacking until now, which for example would allow by simple means for double-pull operation for mechanical and manual opening of the latch mechanism. This is where the invention comes in.

The invention is based on the technical problem of how to further develop this kind of motor vehicle lock, and in particular a motor vehicle door lock, in such a way that in particular a double-pull operation can be combined, in an easy and functionally reliable way and by a simple method, with an electromotive actuator to apply force to the coupling element.

To solve this technical problem, the invention proposes, for a generic motor vehicle lock, and in particular a motor vehicle door lock, that the electromotive actuator acts via a pushing member on the coupling element that is mounted on an actuation lever, whereby the pushing member has a blocking element that, depending on position, acts reciprocally on a stationary counter-blocking element to release the coupling element. The release of the coupling element coincides as a rule with it shifting from its “disengaged” position to the “engaged” position. That is regularly possible because, due to the release, the coupling element gets free of the pushing member, to which by aid of the force is applied and which is held by the electric actuator.

According to the invention, the electromotive actuator is initially equipped with one pushing member. As a rule, the electromotive actuator furthermore also has at least one electric motor and a setting element to which it applies force. A gear may also be placed in between in addition. The setting element, and thus the electromotive actuator as a whole, is further and advantageously set up and designed in one actuating direction for electromotive opening of the latch mechanism. On the other hand, the application of force by the electromotive actuator, and thus by the setting element, in another, different actuating direction usually corresponds to the pushing element having force applied to it. The same thing then also applies in general for the coupling element.

The coupling element is generally a coupling slider mounted linearly backwards and forwards on the actuation lever. This coupling slider can be equipped with an additional spring that shifts the coupling slider into its extended position (“engaged”) vis-à-vis the actuation lever that holds it.

This extended position of the coupling slider corresponds to the fact that, when the actuation lever with the coupling element or coupling slider in its extended position is operated, a release lever as a component of the actuation lever chain is reached and can have force applied to it. For when the coupling element or coupling slider is in its extended position, it juts out beyond a front end of the actuation lever, so that the actuation lever including the coupling slider are able to apply a pivoting force to the release lever. By contrast, a retracted position of the coupling slider (“disengaged”) does not allow for application of a force to the release lever.

The application of pivoting force to the release lever when the coupling slider is in the “engaged” position leads then, in turn, to the detent pawl being lifted away, by aid of the release lever, from its latching engagement with the rotary latch. After that, the rotary latch opens, under spring tension, and releases a previously caught lock bar. The associated motor vehicle door can be opened, by mechanical means, by manual application of force to the actuation lever chain.

In detail, that can be done via an interior or an exterior door handle. That is, the actuation lever in question can be fundamentally an interior actuation lever or an exterior actuation lever. Even a so-called central actuation lever is conceivable, which might be part of either an interior or an exterior actuation lever chain, or both.

According to the invention, the electromotive actuator causes, via the pushing member, an application of force to the coupling element or the coupling slider positioned in a linearly slideable manner on the actuation lever.

Depending on the actuating direction of the electromotive actuator, the coupling element can thus take the “engaged” or “disengaged” position. Typically, the coupling element is in the “disengaged” position in normal operation, so that an application of force to the actuation lever will have no effect on the release lever and thus on the latch mechanism.

Starting from this “locked” or “secured condition” of the actuation lever chain, if the intention is to open the latch mechanism mechanically or manually, then typically and according to the invention a double-pull operation of the actuation lever is used. In the course of the first pull of the actuation lever, the actuation lever in question, generally with a repelling arm positioned on it to apply force to the blocking element, ensures that first, by means of the blocking element, the pushing member is moved away from the coupling element. In this process, the blocking element assigned to the pushing member, through its reciprocal action with the stationary counter-blocking element, in the end causes the coupling element to be released, i.e., it is not (any longer) subject to a force applied by the pushing member, that typically adjoins it, nor shifted into or held in its retracted position. Rather, the release of the coupling element or coupling slider leads to the latter (under tension from the spring, if applicable) shifting automatically into its extended position, which corresponds to the coupling element's “engaged” position. This is usually achieved through an initial pull of the actuation lever.

When force is applied thereafter to the actuation lever with a second pull, the now “engaged” coupling element together with the actuation lever can thus apply force to the release lever in such a way that the latch mechanism is opened. The release of the coupling element from the pushing member, as described above, is produced and effected by the reciprocal action between the blocking element on the pushing member and the stationary counter-blocking element.

This reciprocal action is position-dependent, as it depends on the position taken by the pushing member, which the blocking element affixed to the pushing member also follows. Since, in connection with the described first pull of the actuation lever, the pushing member has a force applied to it by the repelling arm on the actuation lever and by the blocking element positioned between them, the desired position change of the blocking element and thus the reciprocal action with the counter-blocking element are achieved. This reciprocal action depends-- as stated-- on the relative position of the blocking element traveling together with the pushing member compared to the stationary counter-blocking element. Accordingly, the reciprocal action between the blocking element and the counter-blocking element is designed to be not only position-dependent, but also time-limited, namely for only as long as the blocking element and the counter-blocking element are able to act reciprocally on one another at all.

In any case, the design is made overall in such a way that the pushing member, which initially adjoins the coupling element, shifts the coupling element into its “disengaged” position and holds it in this position, against the spring assigned to the coupling element. As a rule, this is ensured by the electromotive actuator.

By contrast, when the coupling element is released from the pushing member, it is able to assume its “engaged” position (under tension from the aforementioned spring). This happens automatically, as a rule, whenever the coupling element gets free of the pushing member that was adjoining it. For this purpose, the blocking element as a rule is designed as a lever with at least two arms, which is mounted on the pushing member in a pivoting manner. The two lever arms are positioned with respect to one another generally at an angle, and in particular at a right angle.

In addition, in a first variant, the possibility exists to design both lever arms as one piece, in other words to attach them firmly to one another so they cannot pivot with respect to one another. By contrast, a second variant provides that the two lever arms are not firmly attached to one another preventing them from pivoting with respect to one another, but rather are connected to one another by a hinge. Either way, at most one lever arm is designed as a setting arm passing across the counter-blocking element and/or elastically deflected by it. By contrast, the other lever arm is a stopping arm that acts reciprocally on the actuation lever. That is, as soon as a force is applied to the actuation lever during the first pull, for the purpose of manual and mechanical opening of the latch mechanism, the repelling arm provided on the actuation lever hits against said stopping arm as a component of the blocking element. In this way, force is applied altogether to the blocking element, along with the pushing member bearing the blocking element, via the repelling arm of the actuation lever.

Consequently, the pushing member is moved away from its position adjoining the coupling element. In this way, the coupling element gets free of the pushing member and can (under tension from the spring assigned to it) be shifted from its previously assumed “disengaged” position into the “engaged” position. Then, with a second pull of the actuation lever, the latch mechanism can be opened mechanically and manually.

At the same time, whenever the pushing member moves back in the direction toward the starting position associated with normal operation, the reciprocal action between the blocking element and the counter-blocking element cause the stopping arm and thus the blocking element as a whole to pivot away from the repelling arm of the actuation lever, and consequently the repelling arm cannot act (any longer) on the blocking element and thus on the pushing member.

After force is applied to the actuation lever as described and the two pulls are executed according to the example, that leads overall to the pushing member again assuming its basic or starting position associated with normal operation, such that the pushing member once again adjoins the coupling element and causes the coupling element to be shifted again from the “engaged” position it had previously taken temporarily into its “disengaged” position associated with normal operation.

All that is achieved while allowing for a structure of simple and functionally reliable design. In addition, the number of functional elements is small, and a single electromotive actuator can be worked with, set up and designed to operate in one direction for electric or electromotive opening of the latch mechanism and in another direction for applying force to the pushing member. In this, its significant advantages can be seen.

The invention is described below in detail based on a drawing depicting only one embodiment.

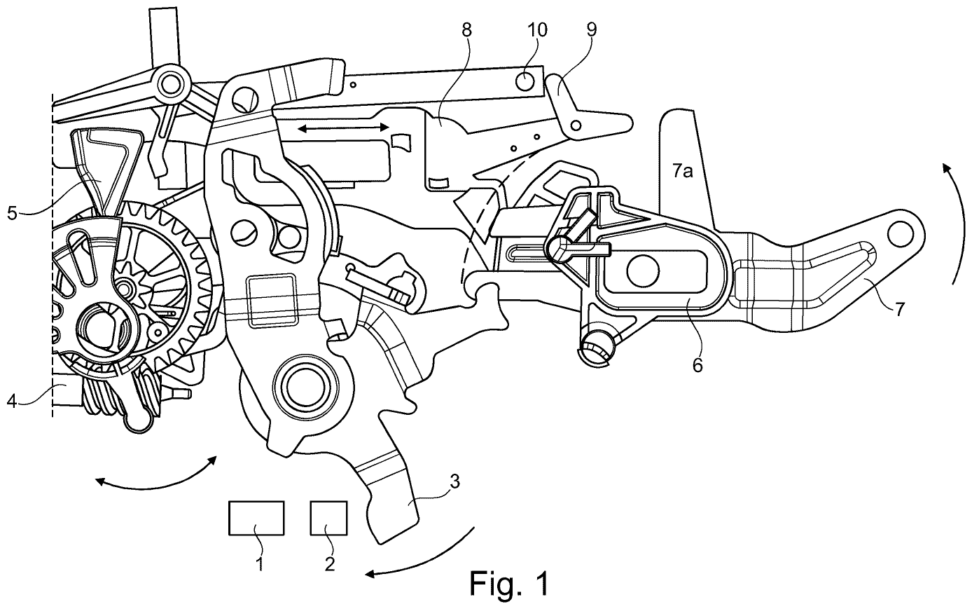

FIG. 1 shows the inventive motor vehicle lock in its basic position in normal operation,

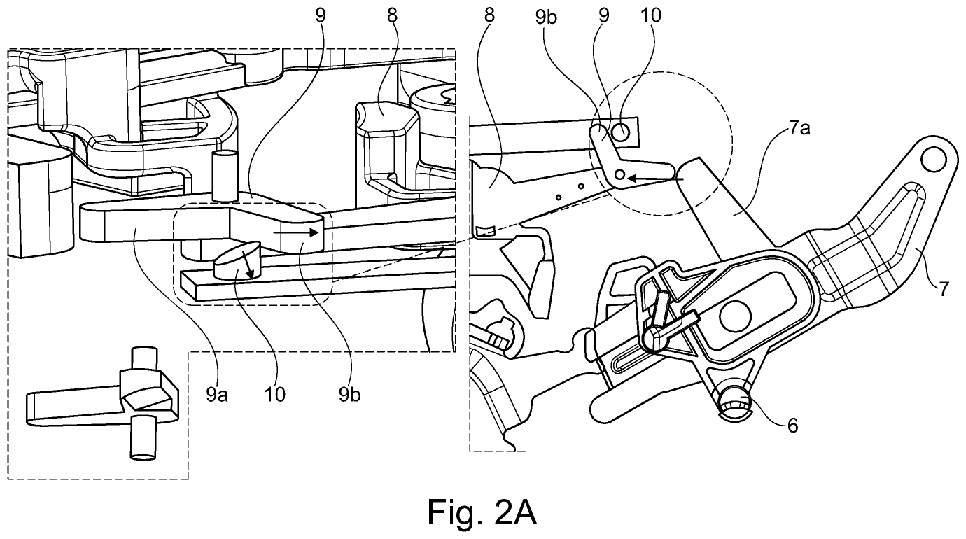

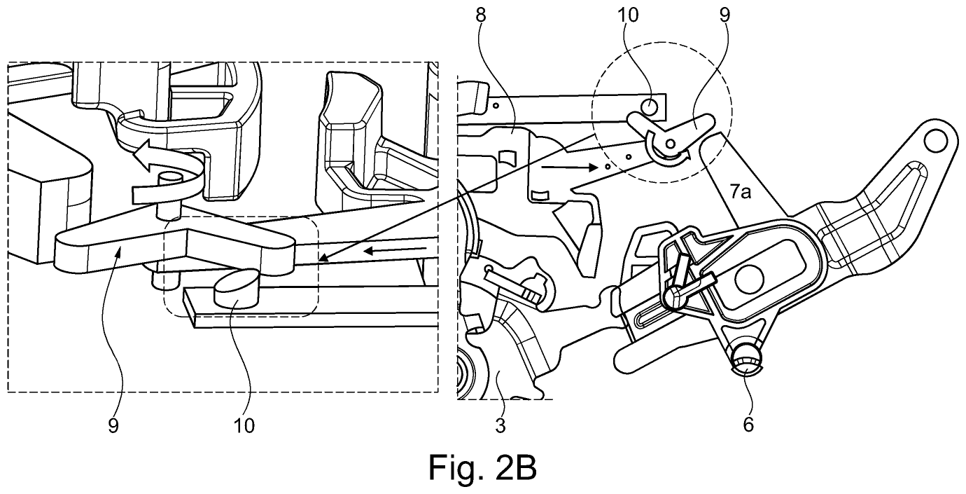

FIGS. 2A and 2B show the transition from the “locked” position depicted in FIG. 1 to the “unlocked” functional condition for opening the latch mechanism in a first variant and

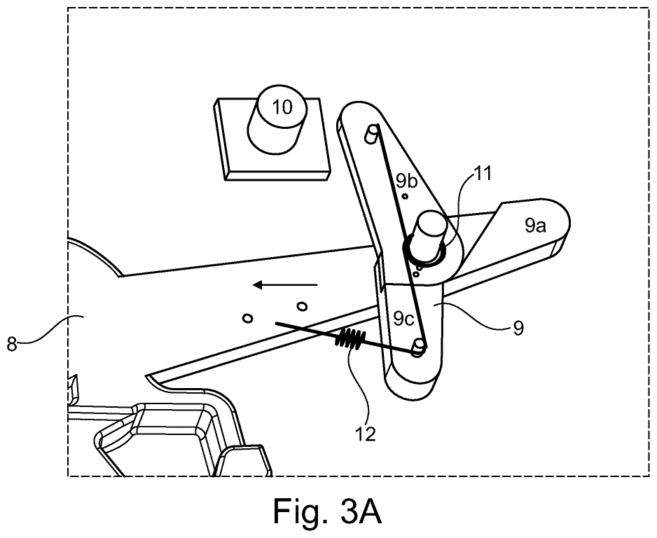

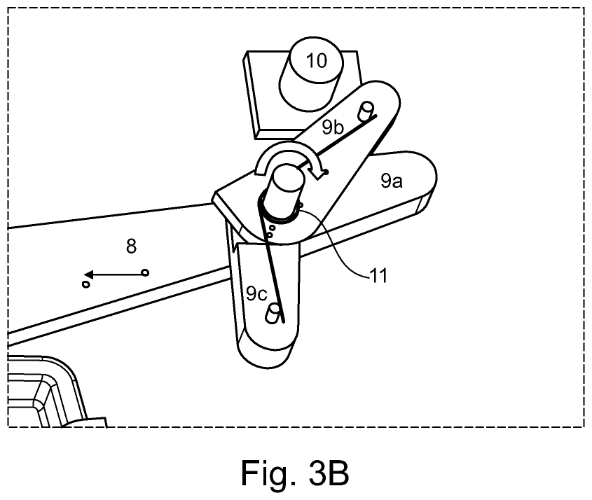

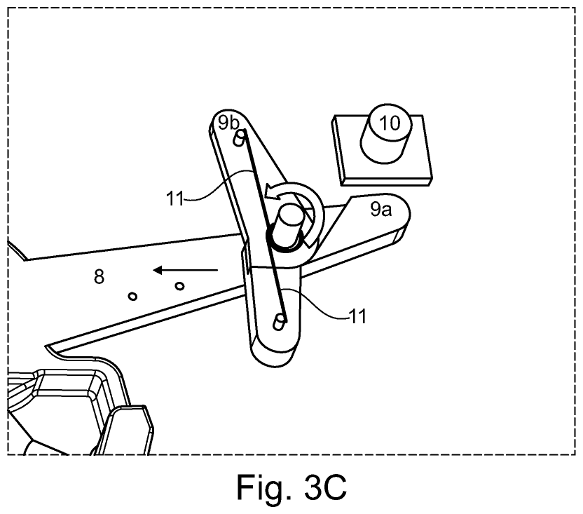

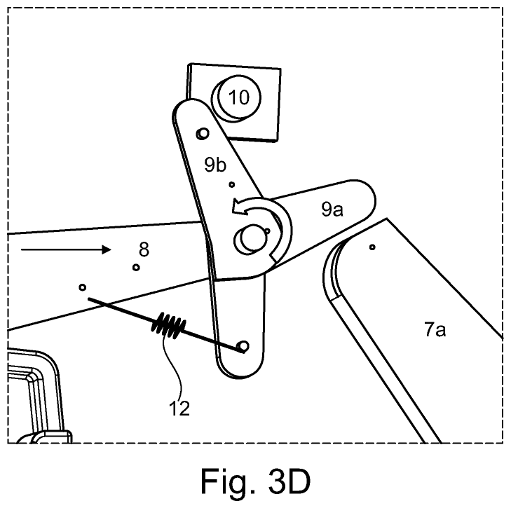

FIGS. 3A through 3D show the object according to FIGS. 1 to 2B in a detailed view in a second variant, once again in the transition from the “disengaged” position of the coupling element into the “engaged” position, and a mechanical and manual opening process following immediately thereafter.

The figures depict a motor vehicle lock, which may be, but need not be, a motor vehicle door lock. It has a latching mechanism 1, 2, consisting essentially of rotary latch 1 and detent pawl 2. Latching mechanism 1, 2 is depicted schematically and in cross section in FIG. 1 only. To open latching mechanism 1, 2, a release lever 3 must be pivoted clockwise around its axis, as indicated by an arrow, according to the drawing in FIG. 1. Release lever 3 can additionally have a force applied to it by aid of an electromotive actuator 4, 5. Electromotive actuator 4, 5 comprises an electric motor or its driven shaft depicted only in FIG. 1, an intervening gearwork, if applicable, and a setting element 5 on the output side, which is particularly relevant for the following observations.

In fact, setting element 5, via an extension arm not explicitly depicted, or in some other way, acts in a counterclockwise motion around its axis, as indicated in FIG. 1, on release lever 3, in such a way that release lever 3 is pivoted clockwise and can open latching mechanism 1, 2. In this case, electromotive actuator 4, 5 works to open latching mechanism 1, 2, functioning therefore as an electromotive opening actuator. Additionally, electromotive actuator 4, 5 can apply force to a coupling element 6 of an actuation lever chain 3, 6, 7. Moreover, said coupling element 6 is mounted according to the embodiment as a coupling element 6 mounted in a linearly slideable manner on an actuation lever 7. Actuation lever 7 for its part may be designed as an interior actuation lever or exterior actuation lever.

For electromotive actuator 4, 5 to be able to apply force to coupling element 6 accordingly, setting element 5 acts on a pushing member 8. Pushing member 8 is connected to setting element 5 for this purpose, for example, by a hinge or in some other way, and performs essentially linear movements in its lengthwise direction, as indicated by a double-arrow in FIG. 1.

In FIG. 1, coupling element 6 mounted on actuation lever 7 is in its “disengaged” position. This presumes that electromotive actuator 4, 5 is applying force via pushing member 8 to coupling element 6 in its retracted position depicted in FIG. 1 (against the force of a spring not shown) and holds it in this position. This corresponds usually to a clockwise rotation of setting element 5, and consequently the application of force by electromotive actuator 4, 5 in the opposite direction compared to the previously described opening process in the electromotive opening of latching mechanism 1, 2, part of which is the application of force on setting element 5 in the counterclockwise direction. Electromotive actuator 5, 6 [sic] can be the sole actuator.

Starting initially at this “disengaged” position of coupling element 6 and thus at the “locked” or “secured” position of the associated and opened actuation lever chain 3, 6, 7, if a crash or a power supply failure of the (sole) electromotive actuator 4, 5 occurs, coupling element 6 may take its “engaged” position, and this is also intended, provided for by the spring assigned to coupling element 6.

This corresponds to coupling element 6 being shifted into an extended position compared to actuation lever chain 7, as depicted with a dashed line in FIG. 1. In this extended position, the spring of coupling element 6 ensures that pushing member 8 (and with it electromotive actuator 4, 5) are held back. With “engaged” coupling element 6 in this dashed-line position, an application of force by actuation lever 7 counterclockwise around its axis as indicated in FIG. 1 now leads via thus closed actuation lever chain 3, 6, 7 to release lever 3 being pivoted clockwise as indicated in FIG. 1, and to detent pawl 2 being lifted thereby away from its latching engagement with rotary latch 1.

Rotary latch 1 can open, under spring tension, and release the previously caught lock bar. An associated motor vehicle door can be opened.

By contrast, the “disengaged” functional position of coupling element 6, depicted continuously in FIG. 1, corresponds to actuation lever chain 3, 6, 7 being open and the counterclockwise motion of actuation lever 7 indicated in FIG. 7 having no effect on release lever 3 and thus on latch mechanism 1, 2.

According to the invention, not only does (sole) electromotive actuator 4, 5 act via pushing member 8 on coupling element 6 mounted on actuation lever 7. Rather, a likewise possible manual and non-motor-driven application of force by actuation lever 7 has the result that in this way, and alternatively to electromotive actuator 4, 5, latching mechanism 1, 2 as a whole can be opened. To this end, pushing member 8, with its blocking element 9 to be described further below affixed thereon, acts reciprocally depending on position on a stationary counter-blocking element 10. This leads overall to coupling element 6 being released from pushing member 8, and therefore, released coupling element 6—under tension from its associated spring—can shift into its “engaged” position.

Moreover, pushing member 8, initially adjoining coupling element 6, shifts coupling element 6 into its “disengaged” position depicted in FIG. 1. So long as electromotive actuator 4, 5 has power, it would ensure that pushing member 8 remains in adjoining contact with coupling element 6 and coupling element 6 also retains its “disengaged” functional position.

If now, in the transition from FIG. 1 to FIG. 2A, latching mechanism 1, 2 is to be opened mechanically and manually by, for example, a double-pull operation of actuation lever 7, a pivoting motion of actuation lever 7 counterclockwise around its axis in the transition from FIG. 1 to FIG. 2A first causes actuation lever 7 to act via repelling arm 7a on blocking element 9. From the enlarged depiction on the left side of FIG. 2A, one can observe that in the embodiment according to FIGS. 2A and 2B blocking element 9 is designed as an at least two-armed lever 9A, 9B mounted in a pivoting manner on pushing member 8. The stationary counter-blocking element 10, in the context of this variant according to FIGS. 2A and 2B, is a peg with a slanted surface.

As a consequence, with the counterclockwise pivoting motion of actuation lever 7 around its axis depicted in FIG. 2A, repelling arm 7a of actuation lever 7 applies force, as indicated by an arrow in FIG. 2A, to an arm 9a of blocking element 9, which is two-armed in this embodiment. The two arms 9a, 9b are preponderantly designed to be at an angle to one another and, in particular, at a right angle, and are further attached firmly to one another so they cannot pivot with respect to one another, that is, are generally designed as one piece.

In any case, the pushing motion of repelling arm 7a on actuation lever 7, depicted in FIG. 2A, in the counterclockwise direction in the first pull, as indicated in FIG. 2A, causes the two-armed blocking element 9 to be able to pass across counter-blocking element 10. For in this process, the other arm 9b of blocking element 9 is in a position to slide across the slanted surface of the peg-like counter-blocking element 10. For this reason, this lever arm 9b is a setting arm 9b passing across or elastically deflected by counter-blocking element 10.

By contrast, the other lever arm 9a acting reciprocally by aid of repelling arm 7a on actuation element 7 acts as a stopping arm 9a.

Starting now from the position in FIG. 2A, as soon as blocking element 9 has reached the position “behind” counter-blocking element 10, the corollary movement of pushing member 8, “to the left” in the embodiment, initially causes coupling element 6 to get free of pushing member 8. As a result, coupling element 6 (by virtue of the spring not shown) can automatically shift into its extended position depicted with dashed lines in FIG. 1. Now when actuation lever 7, starting from its functional position in FIG. 2A or 2B, returns to its basic position in shown in FIG. 1, it not only comes about that coupling element 6 shifts into the “engaged” position. Rather, at the same time, blocking element 9 is removed from repelling arm 7a and thus from actuation lever 7, as can be understood best with the aid of FIG. 2B.

For in the transition from FIG. 2A to FIG. 2B, pretensed pushing member 8, normally likewise spring-loaded in the direction of coupling element 6, with a reversing motion indicated by an arrow in FIG. 2B, causes two-armed blocking element 9 to perform a counterclockwise pivoting motion indicated on the right side of FIG. 2B, so that stopping arm 9a of blocking element 9 is removed from and pivots away from repelling arm 7a. This is produced by counter-blocking element 10, which applies a force to setting arm 9b. As a result, and immediately after the functional position shown in FIG. 2B, actuation lever 7 accordingly, by aid of coupling element 6 which is now in its “engaged” position, can after the reversing process following the first pull in the course of a second pull cause release lever 3 to pivot clockwise, which in turn opens latching mechanism 1, 2; this happens manually and purely mechanically.

At the end of this operation of actuation lever 7, pushing member 8 has returned to its starting position according to the drawing in FIG. 1, so that actuation lever 7, likewise in its basic position, and coupling element 6 mounted linearly on it, can in turn by aid of pushing member 8 (for example, under spring tension) be shifted into the “disengaged” starting position. Now the functional condition according to FIG. 1 has again been achieved and is assumed.

Meanwhile, it should be stressed that the reversing motion of pushing member 8 can be performed either under spring tension or caused by electromotive actuator 4, 5, or under both influences. Of course, other positioning movements not depicted in detail are also possible in this context. One way or another, and starting from the “locked” functional condition in normal operation according to the depiction in FIG. 1, it is possible overall to open latching mechanism 1, 2 via a double-pull operation of actuation lever 7, as explained above in detail.

In the drawings according to FIGS. 3A to 3D, another variant of blocking element 9 is depicted, which differs from that in the previously described embodiment according to FIGS. 2A and 2B essentially by the fact that blocking element 9 in this case is designed to have three arms. Nonetheless, on the one hand, stopping arm 9a that acts reciprocally on repelling arm 7a on actuation lever 7, and on the other hand, setting arm 9B of blocking element 9 that acts reciprocally on counter-blocking element 10, are still produced as before. The other, third arm 9c functions in this case as a spring arm; it serves namely to secure a second spring 12, which is produced in addition to a first spring 11.

FIG. 3A shows a comparable situation to the drawing according to FIG. 2A.

In this case, too, actuation lever 7, to which a counterclockwise force is applied, acts via repelling arm 7a on stopping arm 9a of blocking element 9. At the same time, pushing member 8 is moved “to the left,” as an arrow in FIG. 3A clearly shows. Now in the transition from FIG. 3A to FIG. 3B, it comes about that the two lever arms 9a, 9b, attached to one another by a hinge, are pivoted toward one another, because setting arm 9b hits against counter-blocking element 10 in this process. This causes first spring 11, designed as a leg spring, to form an angle against its spring tension and compared to the undeflected, lengthwise extended position according to FIG. 3A.

This has the result that, as pushing member 8 and blocking element 9 mounted on it move further, setting arm 9b, after passing across counter-blocking element 10, is moved back to its starting position according to the drawing in FIG. 3A by aid of first spring 11, except that it is on the other side of counter-blocking element 10, which has been passed across, as shown in FIG. 3C.

The functional position in FIG. 3C corresponds to the depiction according to FIG. 2A already discussed above, in which blocking element 9 has passed counter-blocking element 10. Now, once the reversing motion of pushing member 8 occurs in the transition from FIG. 3C to FIG. 3D, caused by the spring assigned to pushing member 8, by electromotive actuator 4, 5, or in another way, this causes blocking element 9 with its setting arm 9b to hit against counter-blocking element 10, with the result that blocking element 9 is pivoted counterclockwise according to the drawing in FIG. 3D—comparably to FIG. 2B—, so that stopping arm 9a moves away from repelling arm 7a on actuation lever 7 and reciprocal action is no longer observed.

As a result, when another force is again applied counterclockwise to actuation lever 7 (second pull), coupling element 6 in its “engaged” position can again act on release lever 3, so that in this way and in consideration of actuation lever chain 3, 6, 7, which will then be closed, latching mechanism 1, 2 can be opened manually and mechanically.

### LIST OF REFERENCE SIGNS

Rotary latch 1
Detent pawl 2
Latching mechanism 1, 2
Release lever 3
Actuation lever chain 3 [sic]
Actuator 4, 5
Setting element 5
Coupling element 3, 6, 7 [sic]
Actuation lever chain 3, 6, 7
Coupling element/coupling slider 6
Actuation lever 7
Repelling arm 7a
Pushing member 8
Blocking element 9
Stopping arm 9a
Setting arm 9b
Arm 9c
Counter-blocking element 10
Spring 11
Spring 12

1. A motor vehicle lock comprising:
a linearly displaceable coupling element,
a locking mechanism including:
a rotary latch and
a pawl, and
a release lever configured to actuate the pawl to open the locking mechanism,
wherein the release lever is designed in two parts including a pawl release lever acting on the pawl and an actuating release lever interacting with an actuating lever and/or drive,
wherein the pawl release lever and the actuating release lever are either coupled together or decoupled from each other via the linearly displaceable coupling element.

2. The motor vehicle lock according to claim 1, wherein the release lever includes a common axis of rotation, and wherein the pawl release lever and the actuating release lever are mounted coaxially to each other around the common axis of rotation.

3. The motor vehicle lock according to claim 2, wherein the linearly displaceable coupling element is mounted coaxially to the pawl release lever and the actuating release levers and is pivoted with the pawl release lever and the actuating release lever about the common axis of rotation.

4. The motor vehicle lock according to claim 2, wherein the linearly displaceable coupling element is equipped with at least one pin configured to selectively couple and decouple the pawl release lever and the actuating release lever.

5. The motor vehicle lock according to claim 4, wherein the at least one pin includes a first pin and a second pin, and the first and second pins are provided opposite each other with respect to the common axis of rotation.

6. The motor vehicle lock according to claim 4 wherein at least one of the pawl release lever and the actuating release lever includes a recess, wherein the at least one pin engages in the recess.

7. The motor vehicle lock according to claim 2, further comprising a thrust element, wherein the linearly displaceable coupling element is configured to be actuated by the thrust element.

8. The motor vehicle lock according to claim 7, wherein the thrust element is designed as a worm wheel.

9. The motor vehicle lock according to claim 7, wherein the linearly displaceable coupling element includes a stop edge, and wherein the thrust element works on the stop edge of the linearly displaceable coupling element.

10. The motor vehicle lock according to claim 7, wherein the thrust element is rotatable about an axis which runs perpendicular to the common axis of rotation of the release lever.

11. The motor vehicle lock according to claim 1, further comprising a sensor configured to detect the pawl of the locking mechanism.

12. The motor vehicle lock according to claim 9, wherein the thrust element is configured to transfer the linearly displaceable coupling element via the stop edge from a coupled position to a decoupled position with respect to the pawl release lever and the actuating release lever.

13. The motor vehicle lock according to claim 9, wherein the thrust element includes an arc contour, wherein the arc contour is configured to act on the stop edge.

14. The motor vehicle lock according to claim 1, further comprising a spring, wherein the spring is configured to act on the linearly displaceable coupling element.

15. The motor vehicle lock according to claim 14, wherein the spring pretensions the linearly displaceable coupling element in a direction of a position in which the linearly displaceable coupling element couples the pawl release lever and the actuating release lever.
